(19) United States
(12) Patent Application Publication
(10) Pub. No.: US 2005/0270961 A1
(43) Pub. Date: Dec. 8, 2005

(54) Optical recording medium

(75) Inventors: Kentaro Iida, Tokyo (JP); Kenji Yamaga, Tokyo (JP); Mamoru Usami, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/862,194

(22) Filed: Jun. 4, 2004

(51) Int. Cl. G11B 7/24

(52) U.S. Cl. 369/272.1; 369/275.1; 369/283

(57) ABSTRACT

An optical recording medium according to the present invention includes a support substrate and a light transmission layer formed on one side of the support substrate and constituted so that data are recorded therein or reproduced therefrom by projecting a laser beam having a wavelength of 380 nm to 450 nm thereonto, wherein the light transmission layer is formed so as to have a thickness of 5 μm to 60 μm. When the light transmission layer is formed so as to have a thickness of 5 μm to 60 μm, it is possible to prevent the optical recording medium from warping due to heat or moisture applied thereto, in a desired manner, even in a next-generation type optical recording medium having asymmetrical structure

### BACKGROUND OF THE INVENTION

The present invention relates to an optical recording medium and, particularly, to an optical recording medium whose warpage can be prevented in a desired manner.

### DESCRIPTION OF THE PRIOR ART

Optical recording media such as the CD, DVD and the like have been widely used as recording media for recording digital data and a next-generation type optical recording medium that offers improved recording density and has an extremely high data transfer rate has been recently proposed. In such a next-generation type optical recording medium, recording density is to be increased by increasing the numerical aperture NA of an objective lens for condensing the laser beam and shortening the wavelength λ of the laser beam.

However, if the numerical aperture NA of the objective lens for condensing the laser beam is increased, then, as shown by Equation (1), the permitted tilt error of the optical axis of the laser beam to the optical recording medium, namely, the tilt margin T, has to be greatly decreased.

$$T ∝ \frac{λ}{d \cdot {NA}^{3}} \qquad ( 1 )$$

In Equation (1), d is the distance from a light incidence plane to the surface of an information recording layer in which data are to be recorded, namely, the thickness of a layer(s) through which a laser beam passes until it reaches the information recording layer. As apparent from Equation (1), the tilt margin T decreases as the numerical aperture NA of the objective lens increases and increases as the thickness d of the layer(s) through which the laser beam passes decreases.

Therefore, in a next-generation type optical recording medium, the tilt margin T is to be increased by forming a thin light transmission layer having a thickness of about 100 μm on an information recording layer and projecting a laser beam from the side of the light transmission layer onto the optical recording medium, thereby recording data therein and reproducing data therefrom.

When data are to be reproduced from such a next-generation type optical recording medium, a laser beam whose power is set to a reproducing power is first projected onto the optical recording medium. Since a region where a recording mark or pit is formed in the optical recording medium has different reflectivity with respect to the laser beam from those of other regions, the amount of the laser beam reflected from the optical recording medium varies dependent upon the presence or absence of a recording mark or pit. Therefore, it is possible to generate a reproduced signal and reproduce data by detecting the amount of the laser beam reflected from the optical recording medium and converting it to an electrical signal using a light detector.

Accordingly, it is necessary for reading data recorded in an optical recording medium in a desired manner to reliably make a laser beam reflected from an optical recording medium enter a light receiving surface of a light detector.

However, in the case where an optical recording medium is greatly warped due to heat or moisture applied thereto during use, since the incident angle of the laser beam entering the optical recording medium greatly varies, it is difficult to reliably make the laser beam reflected from the optical recording medium enter the light detector.

Therefore, in order to reproduce data recorded in the optical recording medium in a desired manner, it is required to reduce the warpage of the optical recording medium.

However, the next-generation type optical recording medium is constituted by sequentially laminating an information recording layer and a resin layer on a support substrate having a thickness of about 1.1 mm and has an asymmetrical structure unlike a DVD type optical recording medium constituted by laminating disk-like substrates each having a thickness of about 0.6 mm via an information recording layer and having a symmetrical structure.

Therefore, since the thicknesses of the support substrate and the light transmission layer are different from each other in the next-generation type optical recording medium, the optical recording medium tends to warp due to heat or moisture applied thereto and, particularly in the case where the support substrate and the light transmission layer are formed of different materials, since rigidity, linear thermal expansion coefficients, Young's modulus, internal stresses or the like are different between the material forming the support substrate and the material for forming the light transmission layer, the optical recording medium much more tends to warp.

Thus, since the next-generation type optical recording medium particularly tends to warp, it is extremely difficult to suppress the warpage thereof in a desired manner.

### SUMMARY OF THE INVENTION

It is therefore an object of the present invention to provide an optical recording medium whose warpage can be prevented in a desired manner.

The inventors of the present invention vigorously pursued a study for accomplishing the above object and, as a result, reached the conclusion that in the case where a light transmission layer was formed so as to have a thickness of 5 μm to 60 μm, it was possible to prevent the optical recording medium from warping due to heat or moisture applied thereto, in a desired manner, even in a next-generation type optical recording medium having asymmetrical structure.

The present invention is based on these findings and the above object of the present invention can be accomplished by an optical recording medium including a support substrate and a light transmission layer formed on one side of the support substrate and constituted so that data are recorded therein or reproduced therefrom by projecting a laser beam having a wavelength of 380 nm to 450 nm thereonto, the light transmission layer being formed so as to have a thickness of 5 μm to 60 μm.

In a preferred aspect of the present invention, the light transmission layer is formed so as to have a thickness of 5 μm to 50 μm. In the case where the light transmission layer is formed so as to have a thickness of 5 μm to 50 μm, it is possible to further suppress the warpage of the optical recording medium.

In a further preferred aspect of the present invention, the light transmission layer is formed so that variation of thickness thereof falls within a range of −5% to 5% in the plane of the light transmission layer. Since a laser beam passes through the light transmission layer, optical characteristics of the light transmission layer such as birefringence and the like have to be substantially uniform in the plane thereof and it is preferable to form the light transmission layer so as to have a substantially uniform thickness.

In the case where the variation of thickness of the light transmission layer lies outside of the range of −5% to 5%, since the optical characteristics of the light transmission layer are uneven in the plane of the light transmission layer, it is difficult to make a laser beam accurately follow a track and therefore, it becomes sometimes difficult to record data in the optical recording medium in a desired manner or reproduce data recorded in the optical recording medium in a desired manner.

In the present invention, it is preferable for the light transmission layer to have light absorbance equal to or smaller than 10% with respect to a laser beam having a wavelength of 380 nm to 450 nm and is more preferable for it to have birefringence equal to or smaller than 30 nm.

In the case where the light transmission layer has light absorbance equal to or smaller than 10% with respect to a laser beam having a wavelength of 380 nm to 450 nm, the laser beam can pass through the light transmission layer without the reduction in the amount thereof and it is therefore possible to record data in the optical recording medium in a desired manner or reproduce data recorded in the optical recording medium in a desired manner.

In a further preferred aspect of the present invention, the optical recording medium further includes a moisture-proof layer formed on the other side of the support substrate for preventing water from entering the support substrate.

In the case where water enters the support substrate, the support substrate expands or contracts, so that the optical recording medium sometimes warps. However, in the case where a moisture-proof layer is formed on the other side of the support substrate, it is possible to effectively prevent water from entering the support substrate and it is therefore possible to more effectively prevent the optical recording medium from warping.

The above and other objects and features of the present invention will become apparent from the following description made with reference to the accompanying drawings.

### BRIEF DESCRIPTION OF THE DRAWINGS

FIG. 1 is a schematic perspective view showing an optical recording medium that is a preferred embodiment of the present invention.

FIG. 2 is an enlarged schematic cross-sectional view of the part of the optical recording medium indicated by A in FIG. 1.

FIG. 3 is a graph showing a relationship between the thickness of a light transmission layer and the degree of warpage of an optical recording medium when ambient temperature was changed from 25° C. to 70° C.

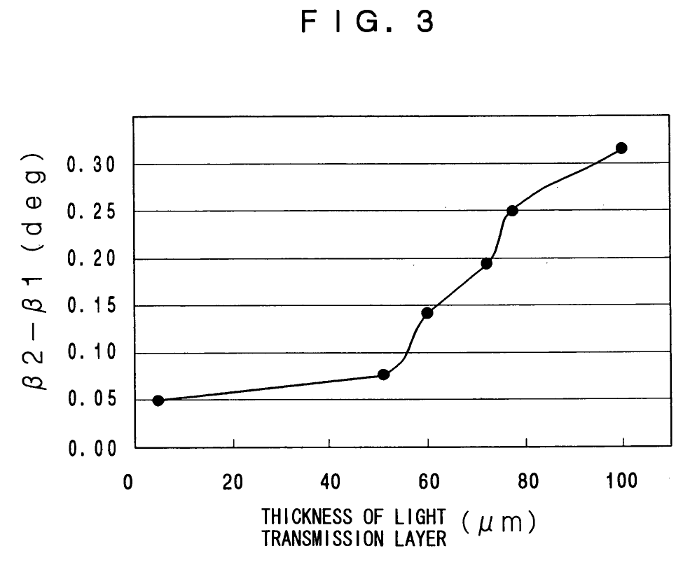

FIG. 4 is a graph showing a relationship between the thickness of a light transmission layer and the degree of warpage of an optical recording medium when the optical recording medium was held in atmosphere at a temperature of 80° C. and a relative humidity of 85%.

### DESCRIPTION OF THE PREFERRED EMBODIMENTS

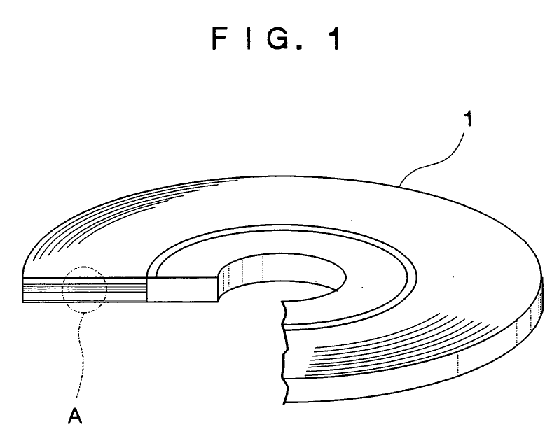

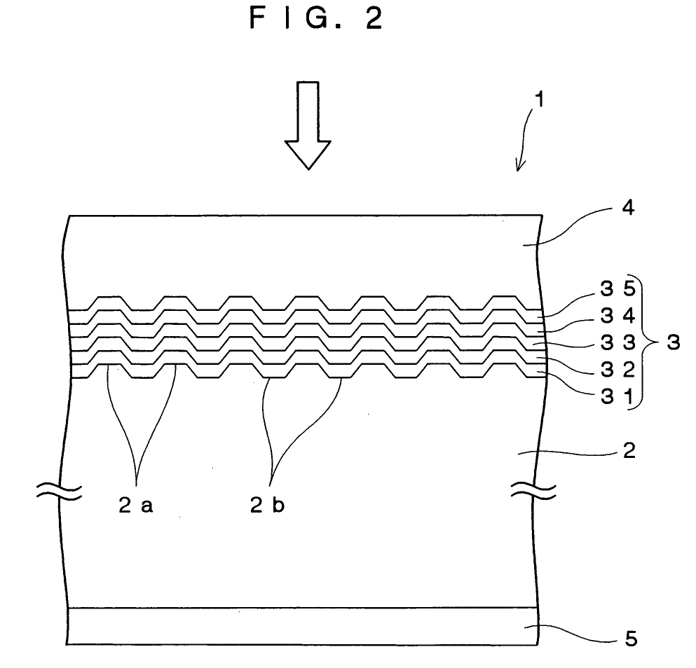

FIG. 1 is a schematic perspective view showing an optical recording medium that is a preferred embodiment of the present invention and FIG. 2 is a schematic enlarged cross-sectional view indicated by A in FIG. 1.

As shown in FIG. 1, an optical recording medium 1 according to this embodiment is formed disk-like and is formed with a center hole at the center portion thereof for setting the optical recording medium 1 to a data recording and reproducing apparatus.

The optical recording medium 1 shown in FIGS. 1 and 2 is so constituted that a laser beam having a wavelength λ of 380 nm to 450 nm is projected via an objective lens (not shown) having a numerical aperture NA which satisfies that A/NA is equal to or smaller than 640 nm in a direction indicated by an arrow in FIG. 2, whereby data are recorded therein or data are reproduced therefrom.

As shown in FIG. 2, the optical recording medium 1 includes a support substrate 2, an information recording layer 3 formed on one surface of the support substrate 2, a light transmission layer 4 formed on the information recording layer 3 and a moisture-proof layer 5 formed on the other surface of the support substrate 2.

The support substrate 2 serves as a support of the optical recording medium 1.

The material used to form the support substrate 2 is not particularly limited insofar as the support substrate 2 can serve as the support of the optical recording medium 1 and the support substrate 2 can be formed of polycarbonate resin or polyolefin resin, for example. Among these, it is preferable to form the support substrate 2 of polycarbonate resin. The thickness of the support substrate 2 is not particularly limited and the support substrate 2 preferably has a thickness of about 1.1 mm.

Grooves 2a and lands 2b for guiding the laser beam are spirally formed on one surface of the support substrate 2 from a portion in the vicinity of the center thereof toward an outer periphery thereof or from an outer periphery thereof toward a portion in the vicinity of the center thereof. Although not particularly limited, the depth of the groove 2a is preferably set to 10 nm to 40 nm and the pitch of the grooves 2a is preferably set to 0.2 μm to 0.4 μm.

As shown in shown in FIG. 2, the information recording layer 3 includes a reflective film 31 formed on the support substrate 2, a second dielectric film 32 formed on the reflective film 31, a recording film 33 formed on the second dielectric film 32, a first dielectric film 34 formed on the recording film 33, and a heat radiation film 35 formed on the first dielectric film 34.

The reflective film 31 serves to reflect the laser beam entering through the light transmission layer 4 so as to emit it through the light transmission layer 4 and serves to increase a C/N ratio of a reproduced signal by a multiple interference effect.

The material for forming the reflective film 31 is not particularly limited insofar as it can reflect the laser beam and the reflective film 31 can be formed of Mg, Al, Ti, Cr, Fe, Co, Ni, Cu, Zn, Ge, Ag, Pt, Au, Nd, In, Sn or the like. Among these materials, it is preferable to form the reflective layer 31 of a metal material having a high reflectivity, such as Al, Au, Ag, Cu or alloy containing at least one of these metals, such as alloy of Ag and Cu.

The thickness of the reflective film 31 is not particularly limited and the reflective film 31 is preferably formed so as to have a thickness of 10 nm to 300 nm and more preferably formed so as to have a thickness of 20 nm to 200 nm.

The first dielectric film 34 and the second dielectric film 33 serve to physically and chemically protect the recording film 33 and to adjust optical characteristics of the optical recording medium 1 so that the difference in the reflectivity between a portion where a recording mark described later is formed and other portions of the recording film 33 is increased by a multiple interference effect when data recorded in the recording film 33 are reproduced, whereby a reproduced signal having a high C/N ratio can be obtained.

The material for forming the first dielectric layer 34 and the second dielectric layer 32 is not particularly limited and it is preferable to form the first dielectric layer 34 and the second dielectric layer 32 of oxide, nitride, sulfide or fluoride containing at least one metal selected from a group consisting of Si, Al, Ta, Ti, Co, Zr, Pb, Ag, Zn, Sn, Ca, Ce, V, Cu, Fe, and Mg, or a combination thereof.

The first dielectric layer 34 preferably has a thickness of 10 nm to 50 nm. In the case where the first dielectric layer 34 is thinner than 10 nm, it is difficult for the first dielectric layer 34 to serve to protect the recording film 33 and improve optical characteristics of the optical recording medium 1. On the other hand, in the case where the first dielectric layer 34 is thicker than 50 nm, it take a longer time for forming the first dielectric layer 34, thereby lowering the productivity of the optical recording medium 1.

Further, the second dielectric layer 32 preferably has a thickness of 5 nm to 20 nm and more preferably has a thickness of 10 nm to 15 nm. In the case where the second dielectric layer 32 is thinner than 5 nm, it is difficult for the second dielectric layer 32 to serve to protect the recording film 33 and on the other hand, in the case where the second dielectric layer 32 is thicker than 20 nm, it take a longer time for forming the second dielectric layer 32, thereby lowering the productivity of the optical recording medium 1.

The recording film 33 is a layer in which data are to be recorded. In this embodiment, the recording film 33 is formed of a phase change material and data are recorded in the recording film 33 and data are reproduced from the recording film 33 utilizing the difference in reflectivity between when the phase change material is in a crystalline phase and when it is in an amorphous phase.

When data are to be recorded in the recording film 33, a laser beam whose power is modulated between a recording power Pw and a bottom power Pb is projected onto the recording film 33 and a region of the recording film 33 irradiated with the laser beam is heated to a temperature equal to or higher than the melting point of the phase change material. The power of the laser beam is then set to the bottom power Pb, thereby quickly cooling the region of the recording film 33 irradiated with the laser beam and the phase change material is changed to an amorphous state, thereby forming a recording mark.

On the other hand, when data recorded in the recording film 33 is to be erased, a laser beam whose power is modulated between the recording power Pw, the bottom power Pb and an erasing power Pe is projected onto the recording film 33, thereby heating a region of the recording film 33 irradiated with the laser beam to temperature equal to or higher than the crystallization temperature of the phase change material and the phase change material is crystallized, thereby erasing a recording mark. Since the phase change reactions of the phase change material contained in the recording film 33 from an amorphous phase to a crystalline phase and from the crystalline phase to the amorphous phase are reversible, data recorded in the recording film 33 can be repeatedly rewritten.

The phase change material for forming the recording film 33 is not particularly limited but a material capable of changing from an amorphous phase to a crystal phase in a short time is preferable in order to rewrite data recorded in the recording film 33 at a high velocity. Illustrative examples of materials having such a characteristic include a SbTe system material. As the SbTe system material, SbTe may be used alone or a SbTe system material to which additives are added in order to shorten time required for crystallization and improve the long-term storage reliability of the optical recording medium 10 may be used.

Concretely, it is preferable to form the recording film 33 of a SbTe system material represented by the compositional formula: (SbₓTe₁ₓ)_{1y}M_{y}, where x is equal to or larger than 0.55 and equal to or smaller than 0.9 and y is equal to or larger than 0 and equal to or smaller than 0.25, and it is more preferable to form the recording film 33 of a SbTe system material represented by the above mentioned compositional formula wherein x is equal to or larger than 0.65 and equal to or smaller than 0.85 and y is equal to or larger than 0 and equal to or smaller than 0.25.

M is an element other than Sb and Te and while M is not particularly limited, it is preferable for the element M to be one or more elements selected from the group consisting of In, Ag, Au, Bi, Se, Al, P, Ge, H, Si, C, V, W, Ta, Zn, Mn, Ti, Sn, Pd, Pb, N, O and rare earth elements in order to shorten time required for crystallization and improve the storage reliability of the optical recording medium 1.

It is preferable to form the recording film 33 so as to have a thickness of 2 nm to 40 nm, is more preferable to form it so as to have a thickness of 4 nm to 30 nm and is further preferable to form it so as to have a thickness of 5 nm to 20 nm. In the case where the recording film 33 is thinner than 2 nm, the difference in optical characteristics between before and after recording data becomes small and a signal having a high C/N ratio cannot be obtained when data are reproduced. On the other hand, in the case where the recording film 33 is thicker than 40 nm, the amount of heat required for forming a recording mark becomes great and there is risk of recording sensitivity declining.

The heat radiation film 35 serves to quickly radiate heat generated in the recording film 33 toward a light incidence plane.

The material for forming the heat radiation film 35 is not particularly limited insofar as it can quickly radiate heat generated in the recording film 33 but it is preferable to use a material having a thermal conductivity higher than that of the first dielectric film 34 for forming the heat radiation film 35. Illustrative examples of materials having such a characteristic include oxide, nitride, sulfide or fluoride containing at least one metal selected from a group consisting of Al, Si, Ce, Ti, Zn, Ta, or a combination thereof.

It is preferable for the heat radiation film 35 to have a thickness of 15 nm to 40 nm. In the case where the heat radiation film 35 is thinner than 15 nm, sufficient heat radiation characteristics cannot be obtained and, on the other hand, in the case where the heat radiation film 35 is thicker than 40 nm, it takes much time to form the heat radiation film 35, thereby lowering the productivity of the optical recording medium 1.

The light transmission layer 4 serves to transmit the laser beam and serves as a protecting layer for the surface of the information recording layer 3.

It is required for the light transmission layer 4 to be optically transparent and have small absorption, reflection and birefringence with respect to light within the same wavelength region as that of the laser beam having a wavelength of 390 to 420 nm, and concretely, the light transmission layer 4 preferably has light absorbance equal or smaller than 10% and more preferably has birefringence equal to or smaller than 30 nm.

In the case where the light transmission layer 4 has light absorbance equal or smaller than 10%, a laser beam can pass through the light transmission layer 4 without loss of the amount thereof and it is therefore possible to record data in the information recording layer 3 in a desired manner or reproduce data recorded in the information recording layer 3 in a desired manner.

The light transmission layer is formed of ultraviolet ray curable resin, for example. The resin composition used for forming the first resin layer 4 contains a photo-polymerizable monomer, a photo-polymerizable oligomer, a photo-initiator and other additives as occasion demands. As a photo-polymerizable monomer, one of a molecular weight of less than 2,000 is preferable, and illustrative examples of such monomers include monofunctional acrylate (methacrylate) and multifunctional acrylate (methacryiate). Illustrative examples of photo-polymerizable oligomers include an oligomer containing or introduced with, in the molecule, a functional group such as an acrylic double bond, an allylic double bond, an unsaturated double bond or the like, each of which is bridgeable or polymerizable by irradiation with an ultraviolet ray. As a photo-initiator, conventional photo-initiators can be employed and, for example, a molecular cleavage type photo-polymerization initiator may be employed.

In this embodiment, the light transmission layer 4 is formed so as to have a thickness of 5 μm to 60 μm and it is preferable for it to have a thickness of 5 μm to 50 μm.

In a study done by the inventors of the present invention, it was found that when a light transmission layer 4 was formed so as to have a thickness of 5 μm to 60 μm, even in the case where an optical recording medium 10 was constituted by sequentially laminating an information recording layer 3 and a light transmission layer 4 on a support substrate 2 having a thickness of about 1.1 mm and had asymmetrical structure, it was possible to prevent an optical recording medium 10 from warping due to heat or moisture applied thereto, in a desired manner, and it was further found that when a light transmission layer 4 was formed so as to have a thickness of 5 μm to 50 μm, it was possible to more effectively suppress the warpage of an optical recording medium 10.

Further, as described above, since a laser beam passes through the light transmission layer 4, it is required for the light transmission layer 4 to have substantially uniform optical characteristics such as birefringence and the like in the plane thereof. Therefore, it is preferable to form the light transmission layer 4 so as to have a substantially uniform thickness and concretely, it is preferable to form the light transmission layer 4 so that variation of thickness thereof is within a range of −5% to 5% in the plane in which the light transmission layer 4 falls.

In the case where the variation of thickness of the light transmission layer 4 falls outside of the range of −5% to 5%, the optical characteristics of the light transmission layer 4 are uneven in the plane of the light transmission layer 4, so that it is difficult to make a laser beam accurately follow a track, and therefore, it becomes sometimes difficult to record data in the information recording layer 3 in a desired manner or reproduce data recorded in the information recording layer 3 in a desired manner.

As shown in FIG. 2, the moisture-proof layer 5 is formed on the other surface of the support substrate 2.

The moisture-proof layer 5 serves to prevent water from entering the support substrate 2.

The material used for forming the moisture-proof layer 5 is not particularly limited insofar as it can prevent water from entering the support substrate 2 but it is preferable to form the moisture-proof layer 5 of oxide, nitride, sulfide or fluoride containing at least one metal selected from a group consisting of Si, Zn, Al, Ta, Ti, Co, Zr, Pb, Ag, Sn, Ca, Ce, V, Cu, Fe, Mg, B and Ba, or a dielectric material containing the combination thereof.

It is preferable to form the moisture-proof layer 5 so as to have a thickness of 20 nm to 300 nm and is more preferable to form it so as to have a thickness of 30 nm to 200 nm. In the case where the moisture-proof layer 5 is thinner than 20 nm, it is difficult to form a moisture-proof layer 5 having sufficient moisture-proof characteristics and reliably prevent water from entering the support substrate 2. On the other hand, in the case where the moisture-proof layer 5 is thicker than 300 nm, it takes much time to form the moisture-proof layer 5, thereby lowering the productivity of the optical recording medium 1.

The optical recording medium 1 having the above-described configuration can be fabricated in the following manner.

The support substrate 2 having the groove 2a and the land 2b on one surface thereof is first fabricated by injection molding using a stamper.

Then, the reflective film 31, the second dielectric film 32, the recording film 33, the first dielectric film 34 and the heat radiation film 35 are sequentially formed by a gas phase growth process such as sputtering process on the substantially entire surface of the support substrate 2 on which the groove 2a and the lands 2b are formed, whereby the information recording layer 3 is formed.

Further, ultraviolet ray curable resin is applied by a spin coating method onto the information recording layer 3 to form a coating layer and an ultraviolet ray is projected onto the coating layer, whereby the ultraviolet ray curable resin is cured and the light transmission layer 4 is formed.

Finally, the moisture-proof layer 5 is formed by a gas phase growth process such as sputtering process on the other surface of the support substrate 2.

According to this embodiment, since the light transmission layer 4 is formed so as to have a thickness of 5 μm to 60 μm, even in the optical recording medium 10 having asymmetrical structure, it is possible to prevent the optical recording medium 10 from warping due to heat or moisture applied thereto, in a desired manner.

Hereinafter, working examples will be set out in order to further clarify the advantages of the present invention.

### WORKING EXAMPLE 1

A sample # 1 was fabricated in the following manner.

A disk-like polycarbonate substrate having a thickness of 1.1 mm and a diameter of 120 mm was first fabricated by an injection molding process.

Then, a reflective film containing Ag as a primary component and having a thickness of 100 nm, a second dielectric film containing a mixture of ZnS and SiO₂ and having a thickness of 10 nm, a recording film containing an alloy Sb—Te—Ge as a primary component and having a thickness of 10 nm, a first dielectric film containing a mixture of ZnS and SiO₂ and having a thickness of 20 nm and a heat radiation film containing AlN as a primary component and having a thickness of 30 nm were sequentially formed on one surface of the polycarbonate substrate using the sputtering process, thereby forming an information recording layer.

Further, the polycarbonate substrate formed with the information recording layer was set on a spin coating apparatus and the information recording layer was coated using the spin coating method with ultraviolet ray curable resin having the composition identified below to form a coating layer. Then, an ultraviolet ray was projected onto the coating layer so that a total amount thereof was 1000 mJ/cm², whereby the ultraviolet ray curable resin was cured and a light transmission layer having a thickness of 100 μm was formed.

| | | |
|---|---|---|
| Urethane acrylate (Negami Chemical Industrial | 50 | weight % |
| Co., Ltd; Product Name “ART RESIN UN-5200”) | | |
| Trimethylolpropane triacrylate (NIPPON KAYAKU | 33 | weight % |
| CO., LTD.; Product Name “KAYARAD TMPTA”) | | |
| Phenoxyhydroxypropyl acrylate (NIPPON KAYAKU | 14 | weight % |
| CO., LTD.; Product Name “KAYARAD R-128”) | | |
| 1-hydroxycyclohexyl phenyl ketone (CIBA-GUIGY | 3 | weight % |
| CO., LTD.; Product Name “IRG184”) | | |

Further, samples # 2 and # 3 and comparative samples # 1 and # 2 were fabricated in the manner of the sample # 1 except that light transmission layers were formed so as to have different thicknesses as shown in Table 1.

TABLE 1

| | Thickness of Light |
|---|---|
| | transmission layer |
| | (μm) |
| Sample # 2 | 50 |
| Sample # 3 | 60 |
| Comparative Sample # 1 | 70 |
| Comparative Sample # 2 | 75 |
| Comparative Sample # 3 | 100 |

Then, each of the sample # 1 to the comparative sample # 3 was held at a temperature of 25° C. and a relative humidity of 45% for 24 hours and each of the samples was set in a high-accuracy laser warpage angle measuring machine “LA-2000” (Product Name) manufactured and sold by KEYENCE CORPORATION so that the warpage angle β₁ at a position spaced by 58 mm from the center thereof was measured.

Further, each of the sample # 1 to the comparative sample #3 was set in the above mentioned high-accuracy laser warpage angle measuring machine in an atmosphere of a temperature of 70° C. and relative humidity of 45% and the warpage angle β₂ at a position spaced by 58 mm from the center thereof was measured. During the measurement of the warpage angle β₂ of each sample, the warpage angle was successively measured in the atmosphere of a temperature of 70° C. and relative humidity of 45% until the warpage angle no longer varied and the maximum value thereof was defined as the warpage angle β₂ thereof.

Here, each of the warpage angles β₁ and β₂ was defined to be plus when each sample warped toward the light transmission layer and minus when it warped toward the side opposite to the light transmission layer.

The results of the measurement are shown in Table 2.

TABLE 2

| | Warpage Angle β₁ | Warpage Angle β₂ |
|---|---|---|
| | (deg) | (deg) |
| Sample # 1 | 0.01 | 0.06 |
| Sample # 2 | 0.02 | 0.10 |
| Sample # 3 | 0.05 | 0.19 |
| Comparative Sample # 1 | 0.08 | 0.27 |
| Comparative Sample # 2 | 0.09 | 0.34 |
| Comparative Sample # 3 | 0.14 | 0.45 |

Then, the difference (β₁−β₂) between the warpage angles β₁ and β₂ for each of the sample # 1 to the comparative samples # 3 was calculated and the relationship between the difference (β₁−β₂) and the thickness of the light transmission layer of each sample was further determined. The relationship between the difference (β₁−β₂) and the thickness of the light transmission layer of each sample is shown in Table 3.

As shown in Table 3, it was found that in each of the samples # 1 to # 3 whose light transmission layer had a thickness of 5 μm to 60 μm, the difference (β₁−β₂) was equal to or smaller than 0.15 degrees and the warpage thereof was suppressed even when the ambient temperature was greatly changed. In particular, it was found that in each of the samples # 1 and # 2 whose light transmission layer had a thickness of 5 μm to 50 μm, the difference (β₁−β₂) was equal to or smaller than 0.10 degrees and extremely small. Thus, the warpage thereof was more effectively suppressed. To the contrary, it was found that in each of the comparative samples # 1 to # 3 whose light transmission layer had a thickness outside of the range of 5 μm to 60 μm, the difference (β₁−β₂) caused by the great change in the ambient temperature exceeded 0.15 degrees, and each sample warped greatly.

### WORKING EXAMPLE 2

Samples # 1-2 and # 2-2 and comparative samples # 2-2 and # 3-2 were fabricated similarly to the samples # 1 and # 2 and the comparative samples # 2 and # 3, respectively.

Then, each of the samples # 1-2 and # 2-2 and the comparative samples # 2-2 and # 3-2 was held in an atmosphere of a temperature of 25° C. and a relative humidity of 45% for 24 hours, whereafter each of the samples was set in an optical recording medium evaluation apparatus “DC-1010C” (Product Name) manufactured by cores, Co. Ltd. and the warpage angle β₃ at a position spaced by 58 mm from the center thereof was measured.

Moreover, each of the samples # 1-2 and # 2-2 and the comparative samples # 2-2 and # 3-2 was held in an atmosphere of a temperature of 80° C. and a relative humidity of 85% for 50 hours and was further held in an atmosphere of a temperature of 25° C. and a relative humidity of 45% for 24 hours. Then, the warpage angle β₄ at a position spaced by 58 mm from the center of each sample was measured.

Here, each of the warpage angles β₃ and β₄ was defined to be plus when each sample warped toward the light transmission layer and minus when it warped toward the side opposite to the light transmission layer.

The results of the measurement are shown in Table 3.

TABLE 3

| | Warpage Angle β₃ | Warpage Angle β₄ |
|---|---|---|
| | (deg) | (deg) |
| Sample # 1-2 | 0.01 | 0.03 |
| Sample # 2-2 | 0.02 | 0.06 |
| Comparative Sample # 2-2 | 0.09 | 0.20 |
| Comparative Sample # 3-2 | 0.14 | 0.38 |

Then, the difference (β₃−β₄) between the warpage angles β₃ and β₄ for each of the sample # 1-2 to the comparative samples # 3-2 was calculated and the relationship between the difference (β₃−β₄) and the thickness of the light transmission layer of each sample was further determined.

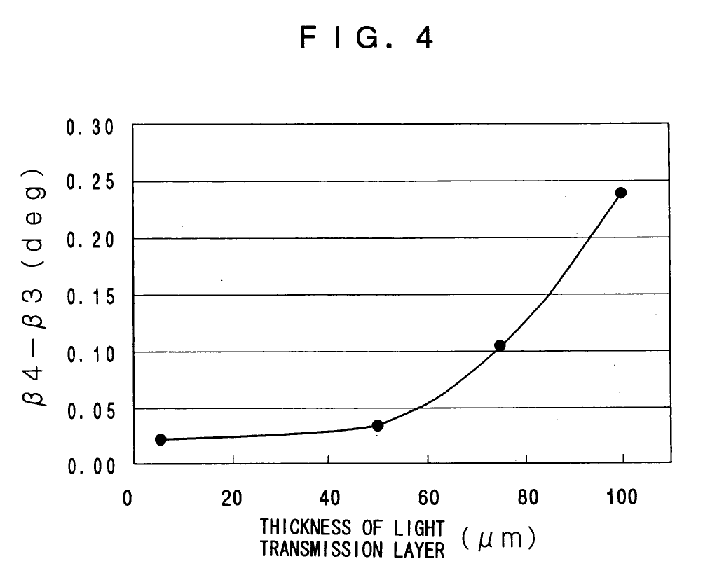

The relationship between the difference (β₃−β₄) and the thickness of the light transmission layer of each sample is shown in FIG. 4.

As shown in FIG. 4, it was found that in each of the samples # 1-2 and # 2-2 whose light transmission layer had a thickness of 5 μm to 60 μm, the difference in the warpage angle was equal to or smaller than 0.10 degrees even after it had been held at a temperature of 80° C. and a relative humidity of 85% for 50 hours, and the warpage thereof was suppressed and small. To the contrary, it was found that in each of the comparative samples # 1-2 to # 3-2 whose light transmission layer had a thickness outside of the range of 5 μm to 60 μm, the difference in the warpage angle after it had been held at a temperature of 80° C. and a relative humidity of 85% for 50 hours exceeded 0.15 degrees, and it warped greatly.

The present invention has thus been shown and described with reference to a specific embodiment and working examples. However, it should be noted that the present invention is in no way limited to the details of the described arrangements but changes and modifications may be made without departing from the scope of the appended claims.

For example, in the optical recording medium 1 shown in FIGS. 1 and 2, although the information recording layer 3 is provided with the phase change type recording film 33 containing a phase change material as a primary component, it is not absolutely necessary for the information recording layer 3 to be provided with the phase change type recording film 33 containing a phase change material as a primary component and an information recording layer 3 may be provided with a recording film containing an organic dye such as a cyanine dye or a porphyrin system dye as a primary component instead of a phase change material.

Further, in the above described embodiment, although the optical recording medium 10 includes an information recording layer 3 and is constituted so that data can be recorded therein by forming a recording mark in the information recording layer 3, it is not absolutely necessary to constitute an optical recording medium so that data can be recorded therein by forming a recording mark in the information recording layer 3 and the present invention can be applied to an optical recording medium constituted so that data can be recorded therein by pits to be formed on the surface of a support substrate 2.

Moreover, in the above described embodiment, although the first dielectric film 34 and the second dielectric film 32 are formed on the opposite sides of the recording film 33, it is not absolutely necessary to form the first dielectric film 34 and the second dielectric film 32 on the opposite sides of the recording film 33 and the first dielectric film 34 may be omitted in the case where the difference in reflectivity between a region of the recording film 33 where a recording mark is formed and regions where no recording mark is formed is large.

Furthermore, in the above described embodiment, although the heat radiation film 35 is provided, it is not absolutely necessary to provide the heat radiation film 35 and the heat radiation film 35 may be omitted in the case where heat generated in the recording film 33 can be quickly radiated by a dielectric film or a reflective film 31 formed in the vicinity of the recording film 33 or the recording film 33 itself.

Moreover, in the above described embodiment, although the reflective film 31 is provided, it is not absolutely necessary to provide the reflective film 31 and the reflective film 31 may be omitted in the case where the difference in reflectivity between a region of the recording film 33 where a recording mark is formed and regions where no recording mark is formed is large.

Further, in the above described embodiment, although the moisture-proof layer 5 is formed on the other surface of the support substrate 2, a moisture-proof layer 5 may be formed on the other side of the light transmission layer 4 with respect to the support substrate 2 and one or more other layers such as a dielectric film may be interposed between the a moisture-proof layer 5 and the support substrate 2.

Furthermore, in the above described embodiment, although the light transmission layer 4 is formed using the spin coating process, it is not absolutely necessary to form the light transmission layer 4 using the spin coating process and a light transmission layer 4 may be formed by adhering an optically transparent resin film having a thickness of 5 μm to 60 μm onto the information recording layer 3.

According to the present invention, it is possible to provide an optical recording medium which can be prevented from warping in a desired manner.

1. An optical recording medium comprising a support substrate and a light transmission layer formed on one side of the support substrate and constituted so that data are recorded therein or reproduced therefrom by projecting a laser beam having a wavelength of 380 nm to 450 nm thereonto, the light transmission layer being formed so as to have a thickness of 5 μm to 60 μm.

2. An optical recording medium in accordance with claim 1, wherein the light transmission layer is formed so as to have a thickness of 5 μm to 50 μm.

3. An optical recording medium in accordance with claim 1, wherein the light transmission layer is formed so that variation of thickness thereof falls within a range of −5% to 5% in the plane of the light transmission layer.

4. An optical recording medium in accordance with claim 2, wherein the light transmission layer is formed so that variation of thickness thereof falls within a range of −5% to 5% in the plane of the light transmission layer.

5. An optical recording medium in accordance with claim 3, wherein the light transmission layer has light absorbance equal to or smaller than 10% with respect to a laser beam having a wavelength of 380 nm to 450 nm.

6. An optical recording medium in accordance with claim 4, wherein the light transmission layer has light absorbance equal to or smaller than 10% with respect to a laser beam having a wavelength of 380 nm to 450 nm.

7. An optical recording medium in accordance with claim 1, which further comprises a moisture-proof layer formed on the other side of the support substrate for preventing water from entering the support substrate.

8. An optical recording medium in accordance with claim 2, which further comprises a moisture-proof layer formed on the other side of the support substrate for preventing water from entering the support substrate.

9. An optical recording medium in accordance with claim 3, which further comprises a moisture-proof layer formed on the other side of the support substrate for preventing water from entering the support substrate.

10. An optical recording medium in accordance with claim 4, which further comprises a moisture-proof layer formed on the other side of the support substrate for preventing water from entering the support substrate.

11. An optical recording medium in accordance with claim 5, which further comprises a moisture-proof layer formed on the other side of the support substrate for preventing water from entering the support substrate.

12. An optical recording medium in accordance with claim 6, which further comprises a moisture-proof layer formed on the other side of the support substrate for preventing water from entering the support substrate.
